(19) United States
(12) Patent Application Publication
(10) Pub. No.: US 2025/0053996 A1
(43) Pub. Date: Feb. 13, 2025

(54) COLLECTIVE CARBON EMISSIONS REDUCTION AT A PORT BY PRIORITIZING ARRIVAL FOR THE QUEUED SET OF VESSELS AND MAXIMIZING THE LOAD FACTOR FOR EACH VESSEL ENABLING SLOW STEAMING LINKED TO THE CARBON EMISSIONS TARGET OF EACH VESSEL

(71) Applicant: VLTN BV, Antwerp (BE)

(72) Inventors: Aristides Halatsis, Thessaloniki (GR); Kostas Zavitsas, London (GB); Stathis Zavvos, Athens (GR); Veerle Leemen, Antwerp (BE); Panayotis Katsoulakos, Haywards Heath (GB)

(73) Assignee: VLTN BV, Antwerp (BE)

(21) Appl. No.: 18/232,259

(22) Filed: Aug. 9, 2023

(51) Int. Cl. G06Q 30/018; B63B 79/40; G06Q 10/0631; G06Q 50/28

(52) U.S. Cl. CPC G06Q 30/018; B63B 79/40; G06Q 10/06312; G06Q 10/08

(57) ABSTRACT

Vessel speed tuning for collective carbon emissions reduction at a port of call includes queuing a set of vessels each steaming towards the port of call, each having a carbon emissions target, determining for each vessel an estimated time to service including cargo unloading and refueling at different arrival times within an arrival time window, computing for each vessel, a cargo load factor resulting from different combinations of arrival time and resulting estimated times to service, optimizing an ordering of arrival for the queued set by minimizing aggregate carbon emissions and maximizing the load factor for each queued vessel according to different permutations of arrival times for the vessels within the arrival time window, constrained by the carbon emissions target of each corresponding vessel, determining slow steaming speeds for each vessel corresponding to the optimized ordering of arrival and transmitting to each vessel, a correspondingly determined slow steaming speed.

### BACKGROUND OF THE INVENTION

### Field of the Invention

The present invention relates to the technical field of collaborative control of the flow of vessels and cargo in a port maximizing the cargo load factor of queued vessels enabling slow steaming linked to the carbon emissions target of each vessel.

### Description of the Related Art

The maritime sector faces a challenging, regulation-driven transition roadmap to ‘zero-emissions” shipping in the coming decades. The difficulties in the de-carbonization transition in oversea shipping as compared to other transport sectors arise mainly because electrification, available for road and rail transport, is not feasible for large powered short-sea or ocean going vessels. In contrast, land transport provides multiple route and mode options and therefore, land transport is known to be more amenable to optimization solutions directed to de-carbonization. Thus, more technically sophisticated strategies are required to achieve zero-emissions goals in overseas shipping.

In this regard, in overseas shipping, the required annual emission reductions, in the short term, can be achieved primarily through a combination of various operational improvement measures including the use of sustainable and more environmentally friendly fuels, and the employment of energy efficient techniques. Slow steaming is an operational measure that improves fuel consumption and therefore reduces emissions. However, slow steaming negatively affects the annual load factor of a subject vessel. By load factor for a vessel it is understood to denote the amount of cargo carried by the vessel over a period of time, in comparison with the maximum potential cargo that could have been transported by the vessel in the same period (i.e. in relation to the loading capacity of the ship).

The load factor is, thus, a function of how much cargo load can be transported by a single vessel over a range of time. However, when the load factor of a subject vessel reduces, this requires excess cargo to be carried by additional vessels thereby increasing the fleet size required to carry a given amount of cargo within a certain timeframe. Therefore, an increasing load factor correlates to reduced carbon emissions over that range of time and a decreasing cargo load factor correlates to increased carbon emissions over that range of time. Consequently, the negative impact of slow steaming on the overall shipping emissions, as well as the reduced earning capacity of vessels operating under slow steaming has prevented the wider adoption of this measure for CO₂ reduction.

Related to slow steaming strategies for CO₂ reduction, two additional emissions reduction measures include both ship speed optimization taking into account weather conditions and also just-in-time cargo arrival in order to avoid the emissions and other costs associated with a longer port servicing time (e.g. waiting at queue to moor, cargo unloading and vessel refueling). In the latter instance, advanced port solutions use queuing models that assume vessels arrive randomly according to a Poisson process with an arrival rate 2, and that the time required to port service a vessel also follows a Poisson distribution with a service rate u. The ratio of Nu is known as the traffic intensity and is used to determine the average number of vessels in the system.

In this regard, it is further understood that ship arrival times can be tuned for different vessels to account for priority classes of different vessels, and other factors that may affect arrival and service times so as to determine optimal scheduling policies and resource allocation strategies. The result is an effort to minimize waiting times and therefore increase the efficiency of port operations. Yet, in doing so, the impact of those optimization strategies fails to account for collective and individual CO₂ reduction goals for both the port and each individual vessel while assuring the performance of respective end to end supply chains.

### BRIEF SUMMARY OF THE INVENTION

Embodiments of the present invention address technical deficiencies of the art in respect to the utilization of slow steaming for carbon emissions reduction. To that end, embodiments of the present invention provide for a novel and non-obvious method for vessel speed tuning for collective carbon emissions reduction at a port of call. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a vessel speed tuning method for collective carbon emissions reduction at a port of call includes queuing a set of vessels each steaming towards the port of call, each of the vessels in the set having a carbon emissions target. The method further includes determining for each of the vessels an estimated time to service the vessel including cargo unloading and refueling at different arrival times within an arrival time window. The method yet further includes computing for each of the vessels, a load factor resulting from different combinations of arrival time and resulting estimated times to service. The method even yet further includes optimizing an ordering of arrival for the queued set of vessels by minimizing aggregate carbon emissions and maximizing the load factor for each of the queued vessels according to different permutations of arrival times for the vessels in the set within the arrival time window, constrained by the carbon emissions target of each corresponding one of the vessels. Finally, the method includes determining slow steaming speeds for each of the vessels corresponding to the optimized ordering of arrival and transmitting to each of the vessels, a corresponding one of the determined slow steaming speeds.

In one aspect of the embodiment, the method additionally includes computing carbon emissions for each of the arrival times for each of the vessels in the queued set and prioritizing one of the arrival times for one of the vessels responsive to a minimized emission of one or more of the vessels based on a Carbon Reduction Index that ranks the vessels according to the level of CO₂ reduction needed to maintain a Carbon Intensity Index [CII] Rating achievable through slow steaming. In another aspect of the embodiment, the method additionally includes computing the aggregate carbon emissions to include not only emissions known for each of the vessels in steaming towards the port of call, but also emissions known to occur in transporting cargo of each of the vessels on an overland route to a target destination. In even yet another aspect of the embodiment, the method further includes recording the arrival times window in a block entry of a remote distributed ledger.

In another embodiment of the invention, a data processing system is adapted for tuning vessel speed based upon arrival time window determination for meeting carbon emissions goals. The system includes a host computing platform including one or more computers, each with memory and one or processing units including one or more processing cores. The system also includes a vessel speed tuning module. The module includes computer program instructions enabled while executing in the memory of at least one of the processing units of the host computing platform to queue a set of vessels each steaming towards the port of call, each of the vessels in the set having a carbon emissions target, to determine for each of the vessels an estimated time to service the vessel including cargo unloading and refueling at different arrival times within an arrival time window and to compute for each of the vessels, a load factor resulting from different combinations of arrival time and resulting estimated times to service.

The program instructions further optimize an ordering of arrival for the queued set of vessels by minimizing aggregate carbon emissions and maximizing the load factor for each of the queued vessels according to different permutations of arrival times for the vessels in the set within the arrival time window, constrained by the carbon emissions target of each corresponding one of the vessels. The program instruction yet further determine slow steaming speeds as appropriate for the vessels corresponding to the optimized ordering of arrival. Finally, the program instructions transmit to the vessels, a corresponding one of the determined slow steaming speeds.

In this way, the technical deficiencies of utilizing slow steaming in oversea shipping are overcome owing to the strategic computation of an arrival time window at the port of call accounting for the necessity of optimizing the load factor of the subject vessel as well as the timings and carbon emissions optimization from a selected one of a multiplicity of different possible inland routes to the destination of the cargo carried by the vessel and any port delays expected in connection with the arrival time window.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of vessel speed tuning for collective carbon emissions reduction at a port of call based on a Carbon Reduction Index;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for vessel speed tuning for collective carbon emissions reduction at a port of call. In accordance with an embodiment of the invention, different vessels steaming towards a port of call are queued for sequencing in order of arrival time based upon the carbon emissions target of each vessel in the queue, an estimated time to service each vessel, and the resulting load factor of each vessel resulting from different combinations of arrival time and resulting estimated times to service. The sequencing reflects an optimization of an ordering of arrival for the vessels in the queue by minimizing aggregate carbon emissions and maximizing the load factor for each queued vessel according to different permutations of arrival times for the vessels in the set within the arrival time window, constrained by the carbon emissions target of each corresponding one of the vessels. Once the sequencing has been determined, slow steaming speeds may be determined for one or more vessel corresponding to the optimized ordering of arrival. Finally, each determined slow steaming speed is transmitted to each corresponding vessel in the queue.

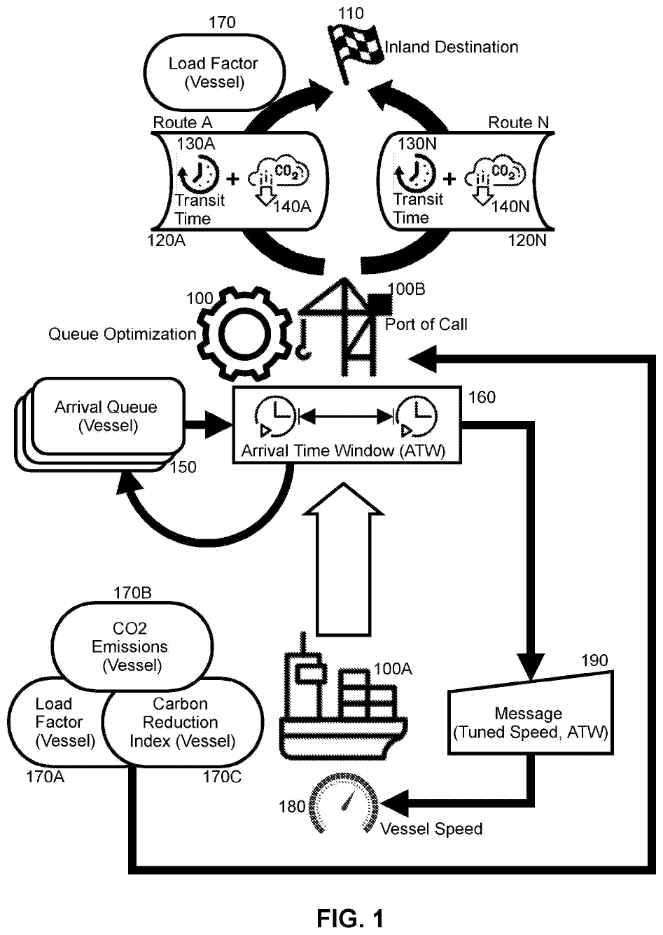

In illustration of one aspect of the embodiment, FIG. 1 pictorially shows a process of vessel speed tuning for collective carbon emissions reduction at a port of call. As shown in FIG. 1, queue optimization logic 100 optimizes an arrival queue 150 of vessels 100A targeting a specific port of call 100B based upon an arrival time window 160 during which the vessels 100A are queued for arrival, servicing and refueling. The optimization accounts for the computation of the load factor 170A of each of the vessels 100A, the CO₂ emissions of each of the vessels 100A, and a carbon reduction index 170C for the set of vessels 100A. The optimization may further account for the CO₂ emissions 140A, 140N computed for a selected one of the overland routes 120A, 120N selected for transporting cargo from each one of the vessels 100A to an inland destination 110, with one of the overland routes 120A, 120N being selected for each one of the vessels 100A based upon a corresponding transit time 130A, 130N for the one of the overland routes 120A, 120N meeting the desired load factor 170 for the one of the vessels 100A.

To that end, the queue optimization logic 100 computes different permutations of load factor 170A and CO₂ emissions 170B for each of the vessels at different arrival times within the arrival time window 160. The queue optimization logic 100 then computes an aggregation of the CO₂ emissions 170B for all of the vessels 100A in the queue 150 according to all of the different permutations of sequencing of the vessels 100A in order to minimize the aggregation of the CO₂ emissions 170B for all of the vessels 100A in the queue 150. However, removed from the permutations are any of the sequences in which the load factor 170A of any one of the vessels 100A falls below a the desired load factor 170 defined for the one of the vessels 100A and any of the sequences in which one of the vessels 100A fails to meet the CO₂ Emissions Target 170C for that one of the vessels 100A. Finally, ones of the sequences are prioritized based upon the CO₂ emissions 170B for one of the vessels falling below the CO₂ emissions 170B of another of the vessels when both vessels compete for the same position in the queue 150.

Once the sequencing of the queue 150 has been optimized by the queue optimization logic 100, the queue optimization logic 100 determines a slow steaming speed 180 for selected vessels 100A based upon a contemporaneous position of these vessels 100A and a designated arrival time within the arrival time window 160. The queue optimization logic 100 then transmits a message 190 to each of the vessels 100A providing both an arrival time within the arrival time window 160 and also the determined slow steaming speed 180. In this way, the vessel speed of each of the vessels 100A may be tuned according to an optimized sequencing of arrival times for each of the vessels 100A in consideration of each of the load factor 170C, CO₂ emissions 170B and carbon reduction index 170C of the vessels 100A.

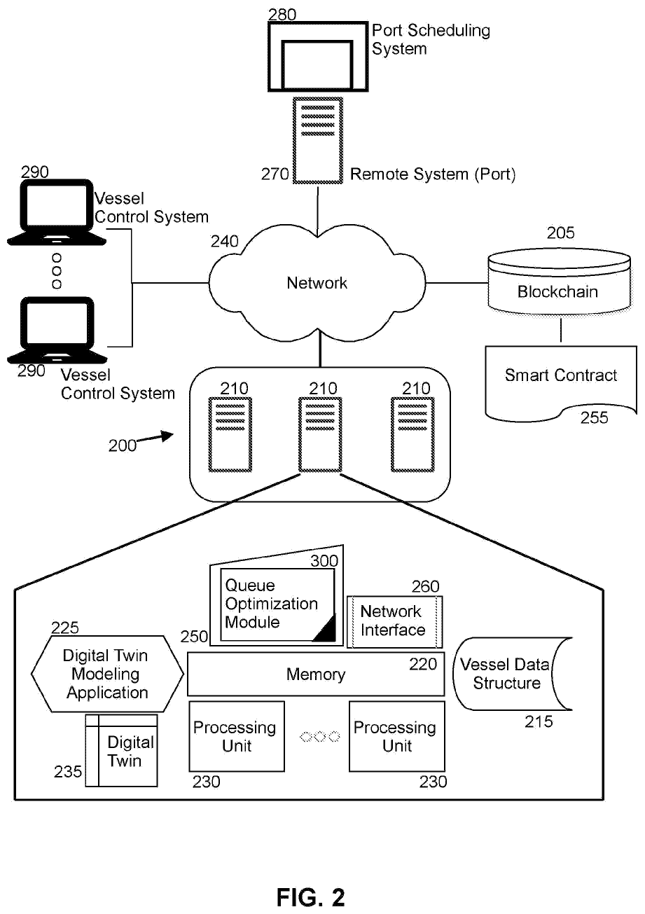

Aspects of the process described in connection with FIG. 1 can be implemented within a data processing system. In further illustration, FIG. 2 schematically shows a data processing system adapted to perform vessel speed tuning for collective carbon emissions reduction at a port of call. In the data processing system illustrated in FIG. 2, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for vessel speed tuning for collective carbon emissions reduction at a port of call. Specifically, the program instructions during execution load into the memory 220 a digital twin 235 of different vessels steaming towards a common port of call for simulation within a digital twin modeling application 225 modeling the aggregate carbon emissions of the vessels along with achieved load factor based upon an arrival time within an arrival time window for each of the vessels in order to compute an optimized sequencing of the vessels for arrival during the arrival time window.

To that end, the program instructions access a vessel data structure 215 in the memory 220 in order to record, for each of the vessels, associated CO₂ emissions achieved at different arrival times in the arrival time window, a contemporaneous load factor achieved at different arrival times in the arrival time window. Then, the program instructions compute aggregate CO₂ emissions for the arrival time window for each permutation of sequencing of the vessels during the arrival time window. The program instructions can select from the different permutations a sequencing of arrival times for the vessels associated with a lowest computed aggregate CO₂ emissions constrained only by the requirement that each of the vessels in the permutations under consideration achieve at least the minimum of a corresponding CII rating and achieve a minimum load factor desired for the vessel.

Once the sequencing has been selected by the program instructions, the program instructions compute a vessel speed for each of the vessels to achieve the desired arrival time for the vessels during the arrival time window. The program instructions then encapsulate the vessel speeds in different respective messages transmitted through the network interface 260 to a vessel control system 290 disposed on each corresponding one of the vessels. Optionally, the program instructions further write to a smart contract 255 in a distributed ledger 205 in respect to each of the vessels, the determined arrival time. As well, the program instructions can upload the optimized sequencing to a port scheduling system 280 of a remote system 270 at the common port of call.

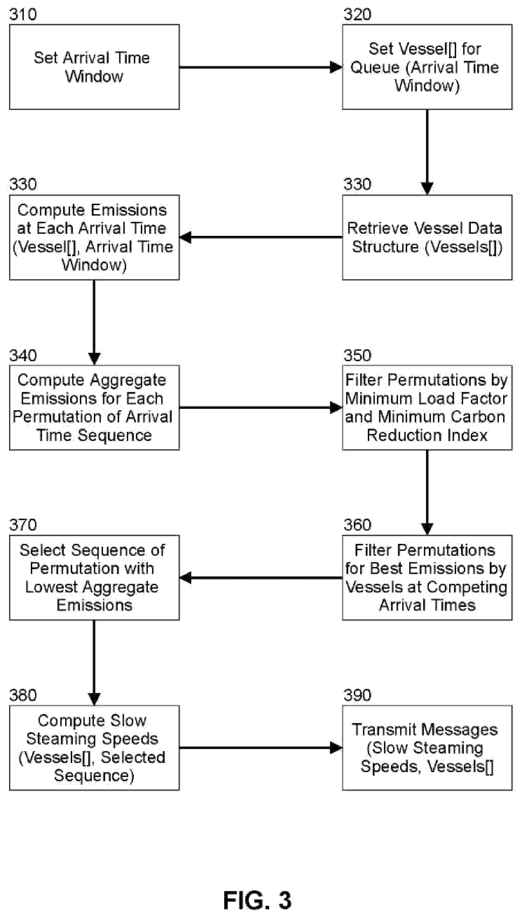

In further illustration of an exemplary operation of the module, FIG. 3 is a flow chart illustrating one of the aspects of the process of FIG. 1. Beginning in block 310, an arrival time window of different arrival times is determined for a selected port of call at which a queue of different vessels has been established, each of the vessels steaming towards the selected port of call at a vessel speed sufficient to position the corresponding vessel at the selected port of call during the arrival time window. In block 320, the set of vessels in the queue is determined for the arrival time window and in block 330, a vessel data structure is retrieved for each of the vessels in the queue including CO₂ emissions of the vessel, a contemporaneous load factor of the vessel, a desired minimum load factor of the vessel and a carbon reduction index for all the vessels.

In block 340, the forecast CO₂ emissions of each vessel in the queue is computed at each arrival time resulting from the steaming of the vessel at a required speed to achieve the arrival time in consideration of the distance of the vessel to the port of call and the atmospheric and sea conditions during the time of voyage from a contemporaneous position and the port of call. Then, in block 350 for each permutation of sequencing of vessel arrival time for the vessels in the queue and the corresponding computed CO₂ emissions for each of the vessels at each possible arrival time in the arrival time window, an aggregate CO₂ emissions value can be determined for the aggregation of the computed CO₂ emissions of the all of the vessels according to the arrival times of each vessel in the sequence of the permutation.

In block 360, the computed permutations may be filtered to exclude any permutation where a resulting load factor of any one of the vessels in the queue falls below the desired minimum load factor for the vessel. As well, permutations are excluded where a resulting CO₂ emissions of any one of the vessels in the queue exceeds permissible CO₂ emissions. In block 370, the permutations are further reduced by excluding amongst a sub-set of the permutations in which two different vessels vie for the same arrival time, all of the permutations in the sub-set excepting for a permutation in which one of the vessels demonstrates better CO₂ emissions than the other of the vessels. Then, in block 380, the sequence of vessels in a permutation showing a lowest aggregate CO₂ emissions value is selected as the optimized sequence and in block 390, and an optimized speed for each of the vessels required to achieve the respective arrival times is computed for each of the vessels. Finally, in block 400 a message is transmitted to each of the vessels with a corresponding speed.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A vessel speed tuning method for collective carbon emissions reduction at a port of call, the method comprising:
queuing a set of vessels each steaming towards the port of call, each of the vessels in the set having a carbon emissions target;
determining for each of the vessels an estimated time to service the vessel including cargo unloading and refueling at different arrival times within an arrival time window;
computing for each of the vessels, a load factor resulting from different combinations of arrival time and resulting estimated times to service;
optimizing an ordering of arrival for the queued set of vessels by minimizing aggregate carbon emissions and maximizing the load factor for each of the queued vessels according to different permutations of arrival times for the vessels in the set within the arrival time window, constrained by the carbon emissions target of each corresponding one of the vessels;
determining optimized speeds for each of the vessels including slow steaming speeds when required corresponding to the optimized ordering of arrival; and,
transmitting to each of the vessels, a corresponding one of the determined speeds.

2. The method of claim 1, further comprising computing carbon emissions for each of the arrival times for each of the vessels in the queued set and prioritizing the arrival times for one or more of the vessels responsive to a minimized emission of the the vessels at risk of falling below target CII level.

3. The method of claim 1, further comprising computing the aggregate carbon emissions to include not only emissions known for each of the vessels in steaming towards the port of call, but also emissions known to occur in transporting cargo of each of the vessels on an overland route to a target destination.

4. The method of claim 1, further comprising recording the arrival times window in a block entry of a remote distributed ledger.

5. A data processing system adapted for vessel speed tuning for collective carbon emissions reduction at a port of call, the system comprising:
a host computing platform comprising one or more computers, each with memory and one or processing units including one or more processing cores; and,
a vessel speed tuning module comprising computer program instructions enabled while executing in the memory of at least one of the processing units of the host computing platform to perform:
queuing a set of vessels each steaming towards the port of call, each of the vessels in the set having a carbon emissions target;
determining for each of the vessels an estimated time to service the vessel including cargo unloading and refueling at different arrival times within an arrival time window;
computing for each of the vessels, a load factor resulting from different combinations of arrival time and resulting estimated times to service;
optimizing an ordering of arrival for the queued set of vessels by minimizing aggregate carbon emissions and maximizing the load factor for each of the queued vessels according to different permutations of arrival times for the vessels in the set within the arrival time window, constrained by the carbon emissions target of each corresponding one of the vessels;
determining optimized speeds for each of the vessels corresponding to the optimized ordering of arrival; and,
transmitting to each of the vessels, a corresponding one of the determined speeds.

6. The system of claim 5, wherein the program instructions further perform computing carbon emissions for each of the arrival times for each of the vessels in the queued set and prioritizing one of the arrival times for one or more of the vessels responsive to a minimized emission of the vessels at risk of falling below target CII levels.

7. The system of claim 5, wherein the program instructions further perform computing the aggregate carbon emissions to include not only emissions known for each of the vessels in steaming towards the port of call, but also emissions known to occur in transporting cargo of each of the vessels on an overland route to a target destination.

8. The system of claim 5, wherein the program instructions further perform recording the arrival times window in a block entry of a remote distributed ledger.

9. A computing device comprising a non-transitory computer readable storage medium having program instructions stored therein, the instructions being executable by at least one processing core of a processing unit to cause the processing unit to tune vessel speed for collective carbon emissions reduction at a port of call by:
queuing a set of vessels each steaming towards the port of call, each of the vessels in the set having a carbon emissions target;
determining for each of the vessels an estimated time to service the vessel including cargo unloading and refueling at different arrival times within an arrival time window;
computing for each of the vessels, a load factor resulting from different combinations of arrival time and resulting estimated times to service;
optimizing an ordering of arrival for the queued set of vessels by minimizing aggregate carbon emissions and maximizing the load factor for each of the queued vessels according to different permutations of arrival times for the vessels in the set within the arrival time window, constrained by the carbon emissions target of each corresponding one of the vessels;
determining optimized speeds for each of the vessels corresponding to the optimized ordering of arrival; and,
transmitting to each of the vessels, a corresponding one of the determined speeds.

10. The device of claim 9, wherein the processing unit further computes carbon emissions for each of the arrival times for each of the vessels in the queued set and prioritizing one of the arrival times for one or more of the vessels at risk of falling below target CII levels.

11. The device of claim 9, wherein the processing unit further computes the aggregate carbon emissions to include not only emissions known for each of the vessels in steaming towards the port of call, but also emissions known to occur in transporting cargo of each of the vessels on an overland route to a target destination.

12. The device of claim 9, wherein the processing unit further records the arrival times window in a block entry of a remote distributed ledger.
